(19) United States
(12) Patent Application Publication
(10) Pub. No.: US 2014/0019957 A1
(43) Pub. Date: Jan. 16, 2014

(54) METHOD, APPARATUS, AND SYSTEM FOR SHARING SOFTWARE AMONG TERMINALS

(71) Applicant: Tencent Technology (Shenzhen) Co., Ltd., Shenzhen (CN)

(72) Inventors: Qing WANG, Shenzhen (CN); Hao Ran GUO, Shenzhen (CN); Quan Hao XIAO, Shenzhen (CN); Yi Xia YUAN, Shenzhen (CN); Jia Shun SONG, Shenzhen (CN); Peng Tao LI, Shenzhen (CN); Xun Chang ZHAN, Shenzhen (CN); Chun You LIN, Shenzhen (CN)

(73) Assignee: Tencent Technology (Shenzhen) Co., Ltd., Shenzhen (CN)

(21) Appl. No.: 14/029,731

(22) Filed: Sep. 17, 2013

Related U.S. Application Data
(63) Continuation of application No. PCT/CN2013/079194, filed on Jul. 11, 2013.

(30) Foreign Application Priority Data
Jul. 11, 2012 (CN) 201210239231.9

(51) Int. Cl. G06F 9/445

(52) U.S. Cl. CPC G06F 8/61
USPC 717/176

(57) ABSTRACT

This discloses a software-sharing method among terminals. The method includes: receiving a request transmitted by a second terminal to obtain a second shared software installation package; obtaining, in accordance with the shared software ID, a default software installation package corresponding to the shared software ID; generating the second shared software installation package in accordance with the default software installation package and an sharing party ID; transmitting the second installation package to the second terminal, allowing installation at the second terminal the shared software using the second installation package. Also disclosed is a server including: a software installation package acquisition request obtaining module, a shared software installation package transmitting module, a shared software installation package generating module, and a default software installation package obtaining module. The embodiment can effectively determine the provider of the shared software when sharing software among terminals, thereby providing better utilization for the operator.

### CROSS REFERENCE TO RELATED APPLICATION

This application is a continuation of International Application No. PCT/CN2013/079194 filed on Jul. 11, 2013, which claims the priority benefit of Chinese Patent Application No. 201210239231.9 filed on Jul. 11, 2012, the content of which are incorporated by reference herein in its entirety for all intended purposes.

### FIELD

The present disclosure relates to communication technologies, and in particular, to a method, apparatus, and system for sharing software among terminals.

### BACKGROUND

As smartphone technology develops, the functions of smartphones are been perfected gradually. Connecting a smartphone to the Internet and downloading software have become routine operations for smartphone users. This has, in turn, resulted in sharing software among the smartphone users. Software sharing can be referring to behavior such as User A downloading software S using his smartphone, recommending the software to User B, and User B following User A's recommendation and downloading and installing software S.

With the existing technology, User A can achieve software sharing via instant messaging User B. The instant message can include a Uniform Resource Locator (URL) used by User A for downloading the software. User B can download the software via the same URL.

As the number of various types of software increases, software sharing is becoming more prevalent. It has also gradually become more important to understand how to better share software and accurately determine the party providing the software for sharing so as to provide better utilization and gradually gain attention for the operator.

### SUMMARY

To better facilitate software sharing and determine the sharing party, embodiments of the disclosure can provide a method of sharing software among terminals. The method can include the following exemplary steps.

Receiving an acquisition request, transmitted from a second terminal, for a second shared software installation package, the acquisition request including a shared software ID and a sharing party ID, the shared software ID identifying the shared software, the sharing party ID identifying a sharing party providing an address of the shared software installation package to the second terminal, the sharing party being one of a first terminal, the second terminal, and a current server.

Obtaining, in accordance with the shared software ID, a default software installation package corresponding to the shared software ID.

Generating, in accordance with the default software installation package and the sharing party ID, the second shared software installation package, the second shared software installation package including the sharing party ID.

And transmitting, to the second terminal, the second shared software installation package, allowing installation at the second terminal the shared software using the second shared software installation package.

Optionally, after transmitting the second shared software installation package to the second terminal, the method can further include: obtaining a terminal ID of the second terminal and the sharing party ID; and determining the sharing party in accordance with the terminal ID of the second terminal, the sharing party ID, and a default server ID.

Wherein determining the sharing party in accordance with the terminal ID of the second terminal, the sharing party ID, and a default server ID further includes the following exemplary steps.

When the sharing party ID is the same as the terminal ID of the second terminal, determining the sharing party to be the second terminal.

When the sharing party ID is the same as the default server ID, determining the sharing party to be the current server.

And when the sharing party ID is different from both the terminal ID of the second terminal and the default server ID, determining the sharing party to be the first terminal.

Embodiments of the disclosure provide another method of sharing software among terminals. The method can include the following exemplary steps.

Receiving software sharing information transmitted from a first terminal, the software sharing information including an address of a second installation package of shared software, the address of the second installation package including a terminal ID of the first terminal.

Transmitting, to the server, an acquisition request for the second shared software installation package in accordance with the address of the second shared software installation package, the acquisition request including a shared software ID and a sharing party ID.

And receiving the second shared software installation package from the server, and installing the shared software in accordance with the second shared software installation package, the second shared software installation package including the terminal ID of the first terminal.

Wherein the first terminal includes the sharing party providing the address of the second installation package to a second terminal, and the terminal ID of the first terminal includes the sharing party ID.

After installing the shared software in accordance with the second shared software installation package, the method can further includes: transmitting the terminal IDs of the first terminal and the second terminal to the server, allowing the server to determine, in accordance with the terminals IDs of the first terminal and the second terminal, the sharing party sharing the shared software to be the first terminal.

Embodiments of the disclosure provide yet another method of sharing software among terminals. The method can include the following exemplary steps.

Generating, in accordance with a terminal ID of a first terminal and an address of a first software installation package, an address of a second software installation package, the address of the second software installation package including the terminal ID of the first terminal, the address of the first software installation package including an address at which the first terminal obtains the first software shared software installation package, the first software installation package including an installation package used by the first terminal for installing the shared software.

And transmitting, to the second terminal, software sharing information including an address of a second software installation package, allowing the second terminal to obtain the second software installation package in accordance with the address of the second software installation package.

Wherein generating, in accordance with the terminal ID of the first terminal and the address of a first software installation package, the address of the second software installation package can further include: obtaining a default configuration path in the address of the first software installation package; and setting the terminal ID of the first terminal as a follow-up path of the default configuration path to obtain the address of the second software installation package.

Embodiments of the disclosure also provide a server including the following exemplary modules.

A software installation package acquisition obtaining module that receives an acquisition request for a second installation software of a shared software from a second terminal, the acquisition request comprising a shared software ID and a sharing party ID, the shared software ID identifying the shared software requested to be acquired, the sharing party ID identifying a sharing party providing the address of the shared software installation package to the second terminal, the sharing party can be one of a first terminal, the second terminal, and a current server.

A default software installation package obtaining module that obtains, in accordance with the shared software ID, a default software installation package corresponding to the shared software ID.

A shared software installation package generating module that generates, in accordance with the default software installation package and the sharing party ID, the second shared software installation package, the second installation package of the shared package comprising the sharing party ID.

And a shared software installation package transmitting module that transmits the second shared software installation package to the second terminal, allowing installation at the second terminal the shared software in accordance with the second shared software installation package.

The server can further include: an ID obtaining module that obtains a terminal ID of the second terminal and the sharing party ID; and a sharing party determining module that determines the sharing party in accordance with the terminal ID of the second terminal, the sharing party ID, and a default server ID.

Wherein the sharing party determining module is configured to: when the sharing party ID is the same as the terminal ID of the second terminal, determining the sharing party to be the second terminal; when the sharing party ID is the same as the default server ID, determining the sharing party to be the current server; and when the sharing party ID is different from both the terminal ID of the second terminal and the default server ID, determining the sharing party to be the first terminal.

Embodiments of the disclosure also provide a second terminal including the following exemplary modules.

A software sharing information receiving module that receives software sharing information transmitted from the first terminal, the software sharing information comprising an address of a second software shared software installation package, the address of the second software shared software installation package including a terminal ID of the first terminal.

A software installation package acquisition request transmitting module that transmits, in accordance with the address of the second software installation package, an acquisition request for the second software installation package to the server, the acquisition request including a shared software ID and a sharing party ID.

A software installation package receiving module that receives the second software installation package transmitted from the server, installs the shared software in accordance with the second software installation package, the second software installation package including a terminal ID of the first terminal, wherein the first terminal includes the sharing party providing the address of the second software installation package to the second terminal, and the terminal ID of the first terminal includes the sharing party ID.

The second terminal can further include an ID transmitting module that transmits the terminal IDs of the first terminal and the second terminal to the server, allowing the server to determine, in accordance with the terminal IDs of the first terminal and the second terminal, that the sharing party sharing the shared software with the second terminal comprises the first terminal.

Embodiments of the disclosure also provide a first terminal including the following exemplary modules.

A software installation package address generating module that generates, in accordance with a terminal ID of the first terminal and an address of a first software installation package, an address of a second software installation package, the address of the second software installation package including the terminal ID of the first terminal, the address of the first software installation package including an address at which the first terminal obtains the first software installation package, the first software installation package including an installation package used by the first terminal to install a shared software.

And a software sharing information transmitting module that transmits, to the second terminal, software sharing information including the address of the second software installation package, allowing the second terminal to obtain the second software installation package in accordance with the address of the second software installation package.

The software installation package address generating module can further include a default configuration path obtaining unit that obtains a default configuration path in the address of the first software installation package; and a software installation package address generating unit that sets the terminal ID of the first terminal as a follow-up path of the default configuration path to obtain the address of the second software installation package.

Embodiments of the disclosure also provide a system for sharing software among terminals. The system includes a first terminal, a second terminal, and a server.

Wherein the first terminal generates, in accordance with a terminal ID of the first terminal and a first installation package address, a second software installation package address including the terminal ID of the first terminal, the first software installation package address used by the first terminal for obtaining an address of a first shared software installation package, the first shared software installation package used by the first terminal for installing the shared software; and transmits software sharing information including an address of a second software installation package to the second terminal.

The second terminal that receives the software sharing information transmitted from the first terminal, the address of the second software installation package including the terminal ID of the first terminal; transmits, in accordance with the address of the second software installation package, an acquisition request for a second shared software installation package to the server, and installs the shared software in accordance with the second shared software installation package, the second shared software installation package including the terminal ID of the first terminal.

The server that receives the acquisition request for the second installation package transmitted from the second terminal, the acquisition request including a shared software ID and a sharing party ID, the shared software ID identifying the shared software being requested for acquisition, the sharing party ID identifying a sharing party providing the address of the shared software installation package to the second terminal, the sharing party comprises one of the first terminal, the second terminal, or the server; obtains, in accordance with the shared software ID, a default software installation package corresponding to the shared software ID; generates the second shared software installation package in accordance with the default software installation package and the sharing party ID, the second shared software installation package including the sharing party ID; and transmits the second shared software installation package to the second terminal, allowing installation at the second terminal the shared software in accordance with the second shared software installation package.

### BRIEF DESCRIPTION OF THE DRAWINGS

To better explain the technical solutions in the embodiments of the disclosure, the figures discussed in the following embodiments are briefly introduced. It should be understood that the figures described below correspond to only some of the embodiments and that other figures can be derived from these figures.

FIG. 1 is a flowchart illustrating the exemplary steps of a software sharing method, according to an embodiment of the disclosure.

FIG. 2 is a flowchart illustrating the exemplary steps of a software sharing method, according to another embodiment of the disclosure.

FIG. 3 is a flowchart illustrating exemplary steps of a software sharing method, according to yet another embodiment of the disclosure.

FIG. 4 is flowchart illustrating exemplary steps of a software sharing method, according to yet another embodiment of the disclosure.

FIG. 5 is a block diagram illustrating the exemplary structure of a server, according to an embodiment of the disclosure.

FIG. 6 is a block diagram illustrating the exemplary structure of a server, according to another embodiment of the disclosure.

FIG. 7 is a block diagram illustrating exemplary structure of a terminal, according to an embodiment of the disclosure.

FIG. 8 is a block diagram illustrating exemplary structure of a terminal, according to another embodiment of the disclosure.

FIG. 9 is a block diagram illustrating exemplary structure of a terminal, according to yet another embodiment of the disclosure.

FIG. 10 is a block diagram illustrating exemplary structure of a terminal, according to yet another embodiment of the disclosure.

FIG. 11 is a block diagram illustrating exemplary structure of a system for sharing software among terminals, according to an embodiment of the disclosure.

FIG. 12 illustrates exemplary common components of a computing system such as the terminals and servers in the various embodiments described below.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

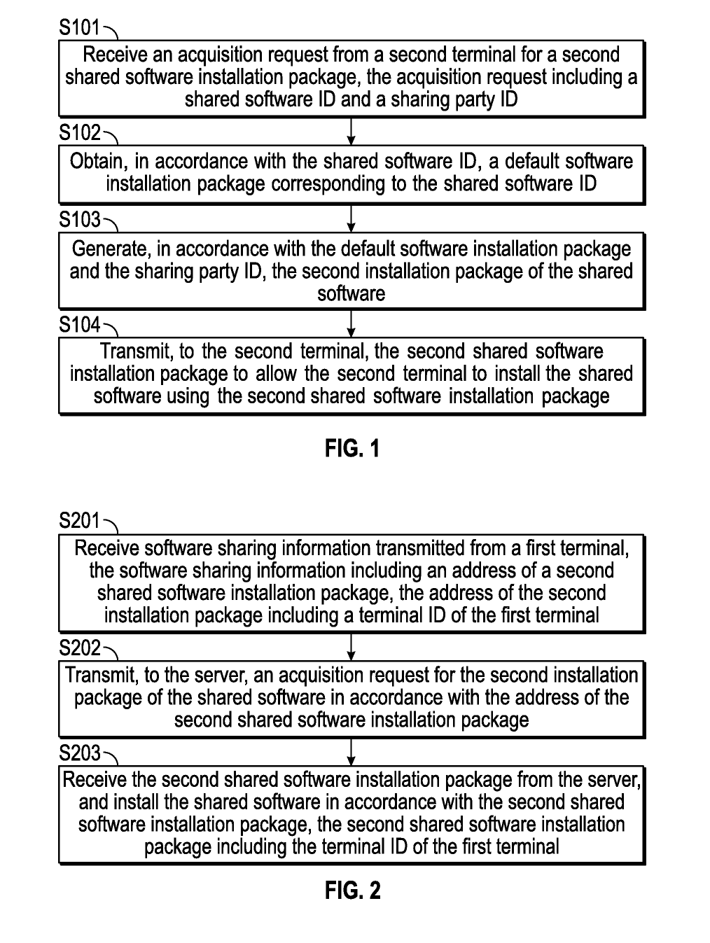

As illustrated in FIG. 1, a method of sharing software among terminals is provided in one embodiment of the disclosure. The method can include the following exemplary steps.

S101: receiving an acquisition request, transmitted from a second terminal, for a second installation package of shared software. The acquisition request can include a shared software ID and a sharing party ID.

The shared software ID can identify the shared software. The sharing party ID can identify a sharing party providing an address of the shared software installation package to the second terminal. The sharing party can be one of a first terminal, the second terminal, and a current server.

S102: obtaining, in accordance with the shared software ID, a default software installation package corresponding to the shared software ID.

S103: generating, in accordance with the default software installation package and the sharing party ID, the second shared software installation package. The second shared software installation package can include the sharing party ID.

S104: transmitting, to the second terminal, the second shared software installation package. This can allow the second terminal to install the shared software using the second shared software installation package.

Optionally, the sharing party ID can be an International Mobile Equipment Identity (IMEI).

It should be noted that the addresses discussed in this embodiment can be URLs. The device performing each of the steps in the disclosed method can be a server or any other device capable of exchanging information with the first and second terminals to facilitate the above-described operations.

In this embodiment, a second shared software installation package can be generated in accordance with the default software installation package and the sharing party ID and transmitted to the second terminal, allowing installation at the second terminal the shared software using the second installation package. This can facilitate the installation of shared software including the sharing party ID at a terminal and, thus, effectively determining the sharing party of the shared software when sharing software among the terminals. As a result, this can provide better utilization for the operator.

As illustrated in FIG. 2, another method of sharing software among terminals is provided in another embodiment of the disclosure. The method can include the following exemplary steps.

S201: receiving software sharing information transmitted from a first terminal. The software sharing information can include an address of a second installation package of shared software. The address of the second installation package can include a terminal ID of the first terminal.

S202: transmitting, to the server, an acquisition request for the second shared software installation package in accordance with the address of the second shared software installation package.

S203: receiving the second shared software installation package from the server, and installing the shared software in accordance with the second shared software installation package. The second shared software installation package can include the terminal ID of the first terminal.

Wherein the first terminal can be the sharing party providing the address of the second installation package to a second terminal. The terminal ID of the first terminal can be the sharing party ID.

It should be noted that the device performing the steps in this embodiment can be the second terminal. The server in this embodiment can be the device performing the steps of the previous embodiment or any other device capable of performing the steps of the previous embodiment. In addition, the first terminal and the second terminal in this embodiment can be the same terminal or different terminals.

In this embodiment, the second terminal can visit, via the server, the address of second software installation package transmitted from the first terminal, obtain, from the server, the second shared software installation package, and install the shared software using the second installation package. Because the second shared software installation package can include the terminal ID of the first terminal, the second terminal can be installed with the shared software including the sharing party ID. Furthermore, the method in the previous embodiment can be facilitated. The sharing party sharing the shared software can be determined to be the first terminal, in accordance with the terminal IDs of the first terminal and the second terminal. As a result, this can provide better utilization for the operator.

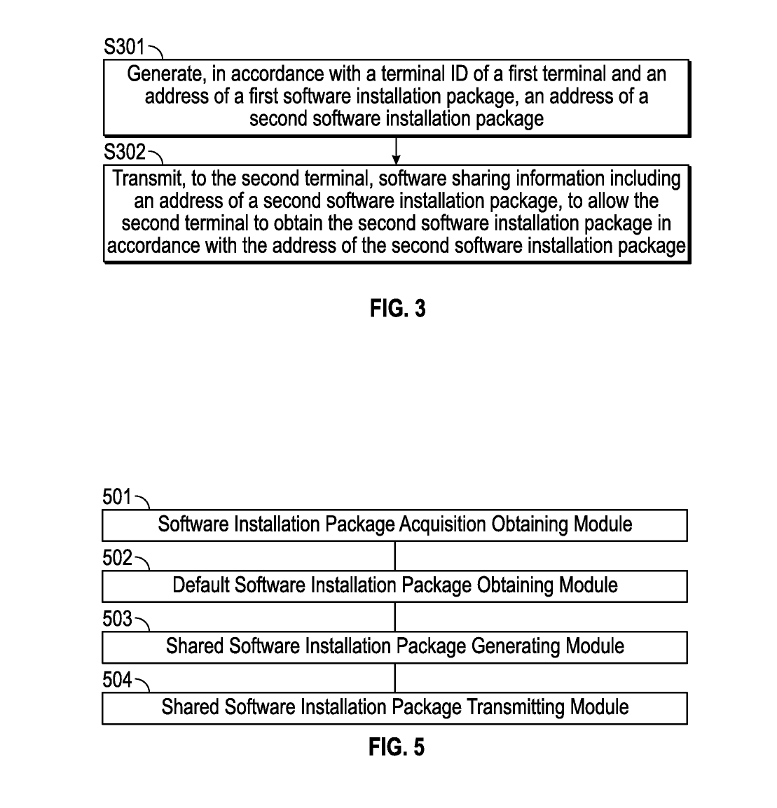

As illustrated in FIG. 3, another method of sharing software among terminals is provided in yet another embodiment of the disclosure. The method can include the following exemplary steps.

S301: generating, in accordance with a terminal ID of a first terminal and an address of a first software installation package, an address of a second software installation package. The address of the second software installation package can include the terminal ID of the first terminal. The address of the first software installation package can include an address at which the first terminal obtains the first software installation package of shared software. The first software installation package can include an installation package used by the first terminal for installing the shared software.

S302: transmitting, to the second terminal, software sharing information including an address of a second software installation package, allowing the second terminal to obtain the second software installation package in accordance with the address of the second software installation package.

In this embodiment, an address of a first software installation package can be generated in accordance with the terminal ID of the first terminal and the address of the second software installation package. Software sharing information including the address of the first software installation package can be transmitted to the second terminal to allow the second terminal to obtain the first shared software installation package in accordance with the first software installation package, thereby facilitating software sharing among the terminals.

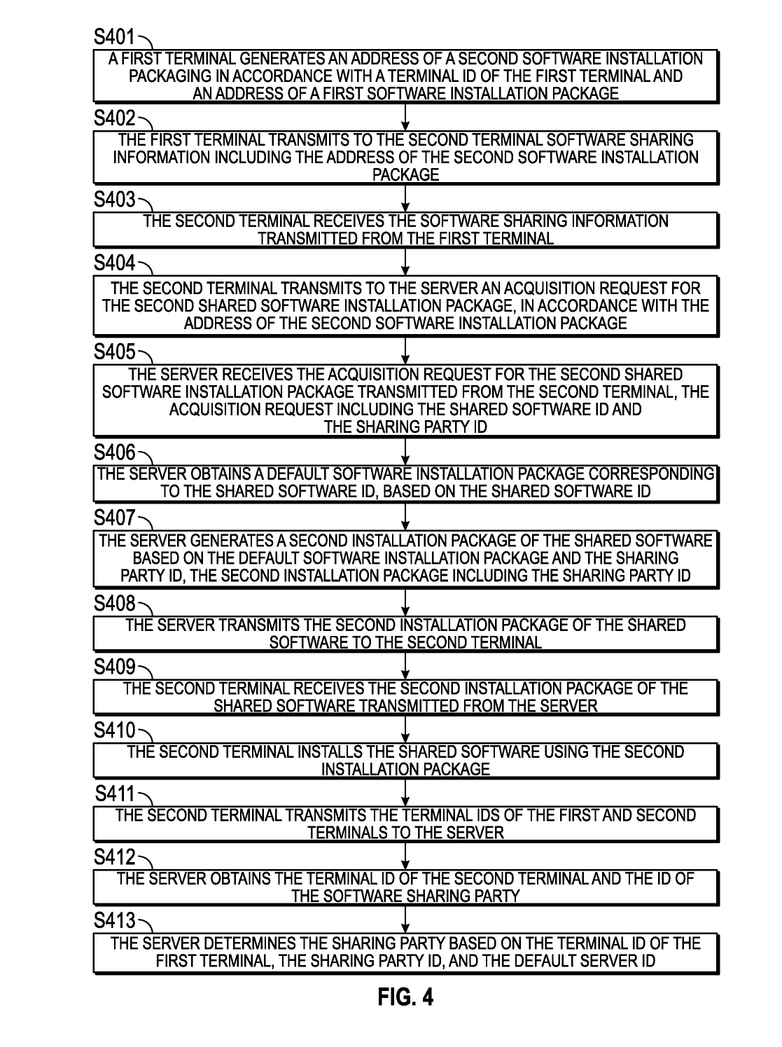

As illustrated in FIG. 4, yet another method of sharing software among terminals is disclosed in another embodiment of the disclosure. The above-described two methods can be combined to better reflect the information exchange between the terminals and the server. The method can include the following exemplary steps.

S401: a first terminal generating an address of a second software installation packaging in accordance with a terminal ID of the first terminal and an address of a first software installation package.

The address of the first software installation package can be an address at which the first terminal obtains the first software installation package. The first software installation package can be the installation package used by the first terminal to install the shared software.

In this step, the first terminal can set the terminal ID of the first terminal as a follow-up path to the default configuration path by obtaining the default configuration path from the address of the first software installation package. The newly-obtained address can be the address of the second software installation package.

For example, the first terminal can be Terminal A and the second terminal can be Terminal B. The terminal ID of the first terminal can be denoted as A_IMEI. If the address at which the first terminal obtains the first software installation package is www.tencent.com/software1/X, the default configuration path can be www.tencent.com. The terminal ID of the first terminal, A-IMEI, can be set as the follow-up path of the default configuration path, www.tencent.com, to obtain a new address of www.tencent.com/A_IMEI. The address www.tencent.com/A_IMEI can be the address of the second software installation package. In addition, to keep the terminal ID secure, the terminal ID of the first terminal can be encrypted. The address of the second software installation package can be generated in accordance with the encrypted terminal ID and the default configuration path. When the terminal ID of the first terminal needs to be used, the address of the second software installation package can be decrypted to obtain the terminal ID of the first terminal.

S402: the first terminal transmitting to the second terminal software sharing information including the address of the second software installation package.

The software sharing information can include the address of the second software shared software installation package. The address of the second software installation package can include the terminal ID of the first terminal.

Optionally, the first terminal can transmit to the second terminal a short messaging server (SMS) message including the address of the second software installation package. Because the address of the second software installation package can be generated in accordance with the terminal ID of the first terminal, the address of the second software installation package can include the terminal ID of the first terminal.

For example, the first terminal A can transmit an SMS message to the second terminal B. The SMS message can include the address of the second software installation package: www.tencent.com/software1/A_IMEI.

S403: the second terminal receiving the software sharing information transmitted from the first terminal.

S404: the second terminal transmitting to the server an acquisition request for the second shared software installation package, in accordance with the address of the second software installation package. The request can include the shared software ID and the sharing party ID.

For example, when the second terminal visits www.tencent.com/software1/A_IMEI, transmission of the second software installation package can be facilitated.

S405: the server receiving the acquisition request for the second shared software installation package transmitted from the second terminal. The acquisition request can include the shared software ID and the sharing party ID.

The shared software can run on the second terminal. The sharing party ID can identify the sharing party providing the address of the shared software installation package to the second terminal. In this step, the sharing party ID can be the terminal ID of the first terminal.

In particular, when the second terminal visits the address of the second software installation package via the server to transmit to the server the acquisition request for the shared software installation package, the second terminal can obtain the shared software ID in accordance with the default configuration path in the address of the second software installation package. For example, the server can receive, from the second terminal, a request for visiting www.tencent.com/software1/A_IMEI. The server can obtain that the shared software ID is “software1” in accordance with the address of the second software installation package and the sharing party ID is A_IMEI.

S406: the server obtaining a default software installation package corresponding to the shared software ID, in accordance with the shared software ID.

In particular, the server can obtain the present software installation package corresponding to the shared software ID in accordance with the locally-stored correspondence between the shared software IDs and the default software installation packages.

For example, the correspondence between the shared software IDs and the present software installation packages can be as shown in table 1. When the shared software ID is software1, the server can obtain the default software installation package software1.exe which corresponds to the shared software ID in accordance with this locally-stored correspondence between the shared software IDs and the default software installation packages.

TABLE 1

| Shared Software ID | Default Software Installation Package |
|---|---|
| Software1 | software1.exe |
| Software2 | Software2.exe |
| Software3 | Software3exe |
| . . . | . . . |

S407: the server generating a second shared software installation package in accordance with the default software installation package and the sharing party ID. The second installation package can include the sharing party ID.

In particular, generating a second shared software installation package in accordance with the default software installation package and the sharing party ID can be within the scope of this disclosure. For example, it can involve embedding the sharing party ID in the default software installation package. The embodiment does not specifically limit the way in which the installation package including the sharing party ID can be generated.

For example, when the default software installation package corresponding to the shared software ID “Software 1” obtained by the server is software1.exe and the sharing party ID is the terminal ID, A_IMEI, of the first terminal, the generated installation package including the sharing party ID can be denoted as software1_A_IMEI.exe.

S408: the server transmitting the second shared software installation package to the second terminal.

For example, the server can transmit the installation package including the sharing party ID, software1_A_IMEI.exe, to the second terminal B.

S409: the second terminal receiving the second shared software installation package transmitted from the server.

For example, the second terminal B can receive the installation package software1_A_IMEI.exe identifying the sharing party.

S410: the second terminal installing the shared software using the second installation package.

For example, the second terminal B can install the shared software using software1_A_IMEI.exe and, at the same time, extract the terminal ID of the first terminal.

S411: the second terminal transmitting the terminal IDs of the first and second terminals to the server.

Optionally, the exchanging of the terminal IDs of the first and second terminals between the second terminal and the server can be actively obtained by the server from the second terminal or be provided by the second terminal when establishing a connection with the server for the first time.

For example, the second server B can transmit the terminal IDs, A_IMEI and B_IMEI of the first terminal and second terminal, respectively, to the server.

In this embodiment, the second terminal can transmit the terminal IDs of the first and second terminals to the server, allowing the server to determine, in accordance with the terminal IDs, that the terminal sharing the shared software with the second terminal is the first terminal. This can facilitate determining the software sharing terminal when software is shared among the terminals.

S412: the server obtaining the terminal ID of the second terminal and the ID of the software sharing party.

For example, the terminal ID of the second terminal obtained by the server can be B_IMEI and the terminal ID of the sharing party can be A_IMEI.

S413: the server determining the sharing party in accordance with the terminal ID of the first terminal, the sharing party ID, and the default server ID.

The default server ID can identify the server transmitting the address of the shared software installation package to the terminal. In particular, when the sharing party ID and the terminal ID of the first terminal are the same, the sharing party can be the first terminal. When the sharing party ID and the default server ID are the same, the sharing party can be the server. When the sharing party ID is not the same as either the terminal ID of the first terminal or the default server ID, the sharing party can be the second terminal.

For example, the terminal ID of the second terminal obtained by the server can be B-IMEI. The sharing party ID can be A-IMEI. The default server ID can be SV_IMEI. The sharing party ID, A_IMEI, can be different from both the default server ID, SV_IMEI, and the terminal ID of the second terminal, B_IMEI. Accordingly, the server can determine that the sharing party sharing the shared software with the second terminal is the first terminal, which corresponds to the sharing party ID A_IMEI.

In this embodiment, only the first terminal transmits the downloading address of the shared software installation package to the second terminal. Alternatively, the second terminal itself or the server can also transmit the download address of the shared software installation package transmitted to the second terminal. The detailed execution of the method can be significantly the same as the disclosed method in this embodiment, and thus is not repeated.

This embodiment discloses obtaining the second shared software installation package transmitted by the server in accordance with the address of the second software installation package transmitted by the first terminal visiting the server, installing the shared software using the second installation package, and transmitting the terminal IDs of the first terminal and the second terminal to the server in accordance with the second software installation package. This can facilitate the server determining the sharing party sharing the software with the second terminal to be the first terminal in accordance with the terminal IDs of the first terminal and second terminal, using the method in the above-described embodiment. As a result, this can provide better utilization for the operator.

As illustrated in FIG. 5, an exemplary server is provided according to an embodiment of the disclosure. The server can include the following exemplary modules.

A software installation package acquisition obtaining module 501 that receives an acquisition request for second installation software of shared software from a second terminal. The acquisition request can include a shared software ID and a sharing party ID. The shared software ID can identify the shared software requested to be acquired. The sharing party ID can identify a sharing party providing the address of the shared software installation package to the second terminal. The sharing party can be one of a first terminal, the second terminal, and a current server.

A default software installation package obtaining module 502 that obtains, in accordance with the shared software ID, a default software installation package corresponding to the shared software ID.

A shared software installation package generating module 503 that generates, in accordance with the default software installation package and the sharing party ID, the second shared software installation package. The second installation package of the shared package can include the sharing party ID.

A shared software installation package transmitting module 504 that transmits the second shared software installation package to the second terminal, allowing installation at the second terminal the shared software in accordance with the second shared software installation package.

In this embodiment, a second shared software installation package can be generated in accordance with the default software installation package and the sharing party ID and transmitted to the second terminal, allowing installation at the second terminal the shared software using the second installation package. This can facilitate the installation of shared software including the sharing party ID at a terminal and, thus, effectively determining the sharing party of the shared software when sharing software among the terminals. As a result, this can provide better utilization for the operator.

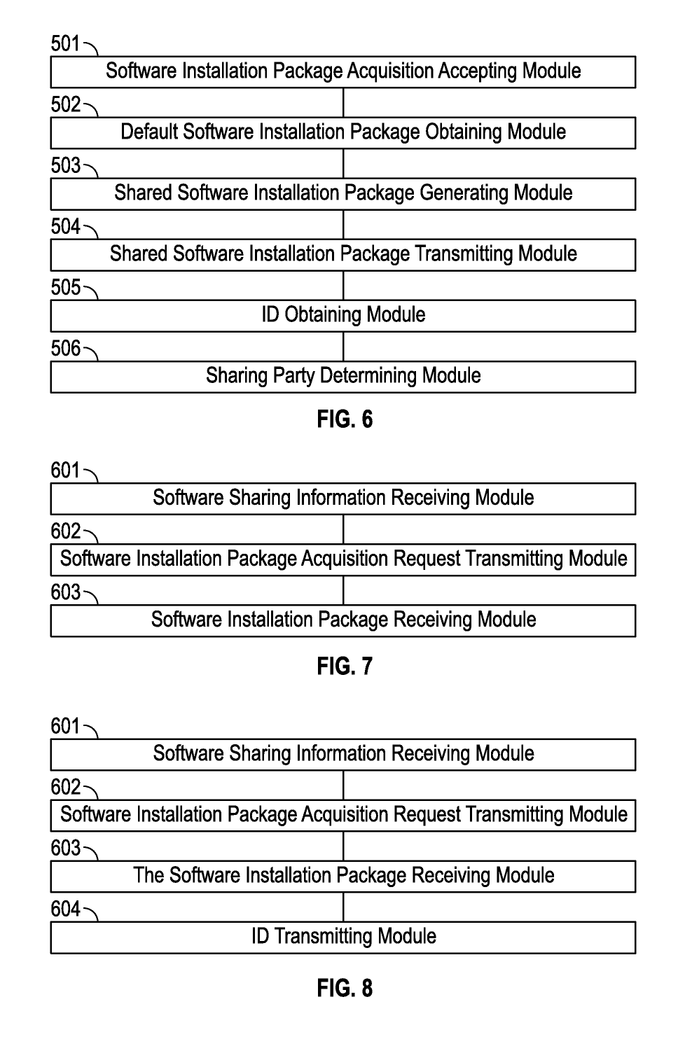

FIG. 6 illustrates an exemplary server, according to another embodiment of the disclosure. The server can include the software installation package acquisition obtaining module 501, the default software installation package obtaining module 502, the shared software installation package generating module 503, and the shared software installation package transmitting module 504 of the above-described embodiment. In addition, the server in this embodiment may also include the following exemplary modules.

An ID obtaining module 505 that obtains a terminal ID of the second terminal and the sharing party ID.

A sharing party determining module 506 that determines the sharing party in accordance with the terminal ID of the second terminal, the sharing party ID, and a default server ID.

The sharing party determining module 506 can be used for, for example, determining the following.

When the sharing party ID is the same as the terminal ID of the second terminal, the sharing party can be the second terminal.

When the sharing party ID is the same as the server ID, the sharing party can be the server.

When the sharing party ID is different from both the terminal ID of the second terminal and the preset server ID, the sharing party can be the first terminal.

This embodiment can effectively determine, in accordance with the terminal ID of the second terminal, the sharing party ID, and the default server ID, the sharing party sharing the shared software when the software is being shared among the terminals. As a result, this can provide better utilization for the operator.

FIG. 7 illustrates an exemplary terminal, according to an embodiment of the disclosure. The terminal can include the following exemplary modules.

A software sharing information receiving module 601 that receives software sharing information transmitted from the first terminal. The software sharing information can include an address of a second software installation package of shared software. The address of the second software shared software installation package can include a terminal ID of the first terminal.

A software installation package acquisition request transmitting module 602 that transmits, in accordance with the address of the second software installation package, an acquisition request for the second software installation package to the server.

A software installation package receiving module 603 that receives the second software installation package transmitted from the server and installs the shared software in accordance with the second software installation package. The second software installation package can include a terminal ID of the first terminal. The first terminal can include the sharing party providing the address of the second software installation package to the second terminal. The terminal ID of the first terminal can include the sharing party ID.

In this embodiment, the second terminal can visit, via the server, the address of second software installation package transmitted from the first terminal, obtain, from the server, the second shared software installation package, and install the shared software using the second installation package. Because the second shared software installation package can include the terminal ID of the first terminal, the second terminal can be installed with the shared software including the sharing party ID. Furthermore, the method in the previous embodiment can be facilitated. The sharing party sharing the shared software can be determined to be the first terminal, in accordance with the terminal IDs of the first terminal and the second terminal. As a result, this can provide better utilization for the operator.

FIG. 8 illustrates an exemplary terminal, according to an embodiment of the disclosure. The terminal can include the software sharing information receiving module 601, the software installation package acquisition request transmitting module 602, and the software installation package receiving module 603 of the previous embodiment. In this embodiment, the terminal can further include the following exemplary modules.

An ID transmitting module 604 that transmits the terminal IDs of the first terminal and the second terminal to the server, allowing the server to determine, in accordance with the terminal IDs of the first terminal and the second terminal, that the sharing party sharing the shared software with the second terminal comprises the first terminal.

In this embodiment, the second terminal can visit, via the server, the address of second software installation package transmitted from the first terminal, obtain, from the server, the second shared software installation package, and install the shared software using the second installation package. Because the second shared software installation package can include the terminal ID of the first terminal, the second terminal can be installed with the shared software including the sharing party ID. Furthermore, the method in the previous embodiment can be facilitated. The sharing party sharing the shared software can be determined to be the first terminal, in accordance with the terminal IDs of the first terminal and the second terminal. As a result, this can provide better utilization for the operator.

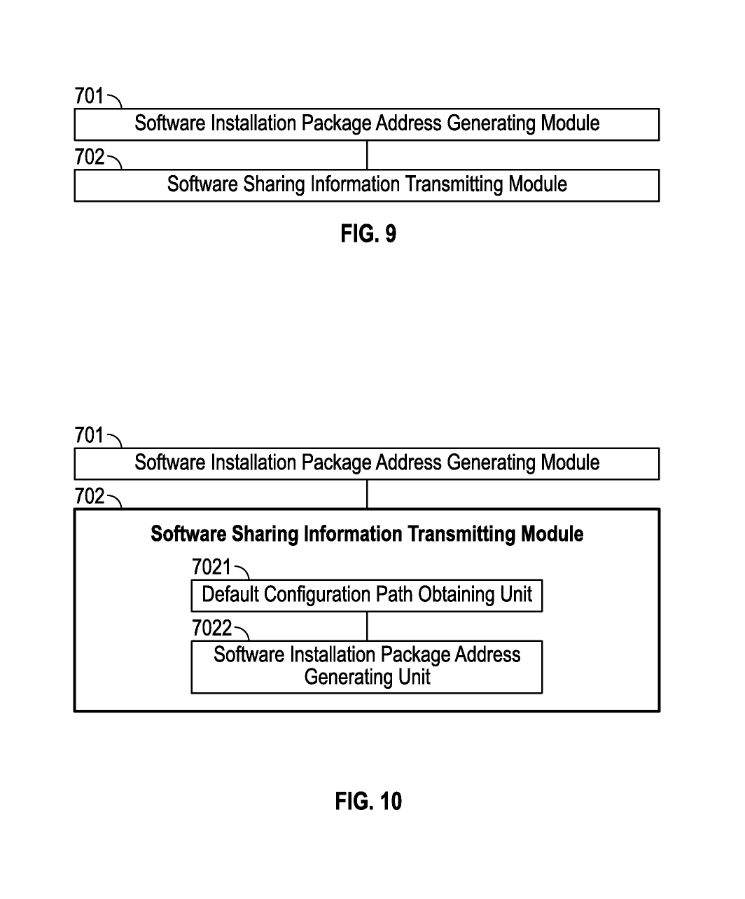

FIG. 9 illustrates an exemplary terminal, according to an embodiment of the disclosure. The terminal can include the following exemplary modules.

A software installation package address generating module 701 that generates, in accordance with a terminal ID of the first terminal and an address of a first software installation package, an address of a second software installation package. The address of the second software installation package can include the terminal ID of the first terminal. The address of the first software installation package can include an address at which the first terminal obtains the first software installation package. The first software installation package can include an installation package used by the first terminal to install shared software.

A software sharing information transmitting module 702 that transmits, to the second terminal, software sharing information comprising the address of the second software installation package, allowing the second terminal to obtain the second software installation package in accordance with the address of the second software installation package.

In this embodiment, an address of a first software installation package can be generated in accordance with the terminal ID of the first terminal and the address of the second software installation package. Software sharing information including the address of the first software installation package can be transmitted to the second terminal to allow the second terminal to obtain the first shared software installation package in accordance with the first software installation package, thereby facilitating software sharing among the terminals.

FIG. 10 discloses an exemplary terminal, according to an embodiment of the disclosure. The terminal can include the software installation package address generating module 701 and the software sharing information transmitting module 702 of the previous embodiment. In addition, in this embodiment, the software installation package address generating module 701 can also include the following exemplary units.

A default configuration path obtaining unit 7021 that obtains a default configuration path in the address of the first software installation package.

A software installation package address generating unit 7022 that sets the terminal ID of the first terminal as a follow-up path of the default configuration path to obtain the address of the second software installation package.

In this embodiment, an address of a first software installation package can be generated in accordance with the terminal ID of the first terminal and the address of the second software installation package. Software sharing information including the address of the first software installation package can be transmitted to the second terminal to allow the second terminal to obtain the first shared software installation package in accordance with the first software installation package, thereby facilitating software sharing among the terminals.

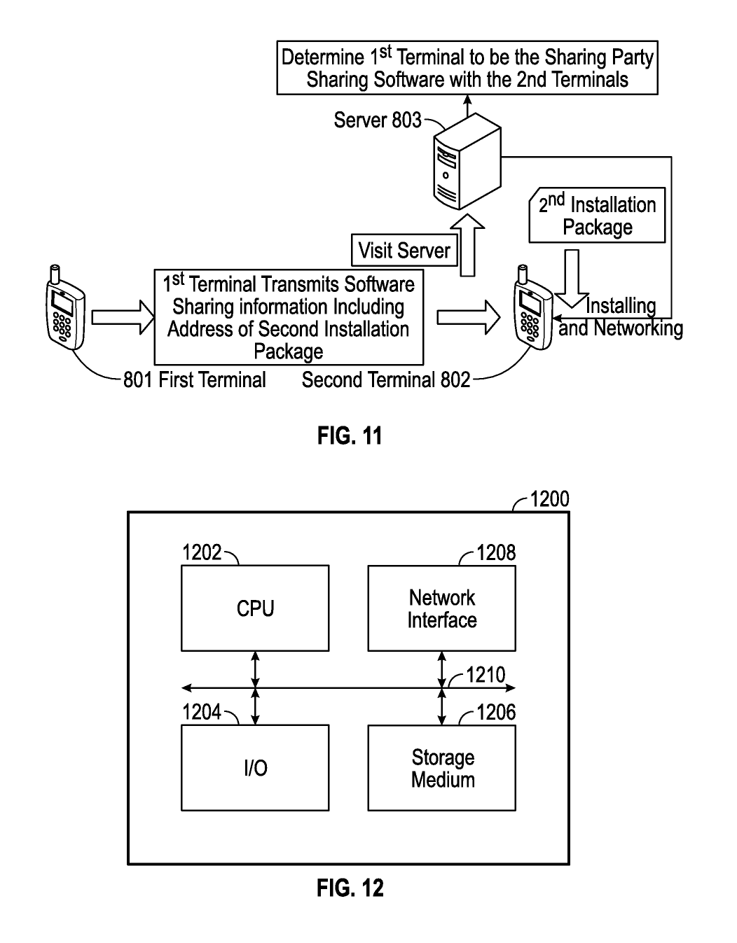

FIG. 11 illustrates an exemplary system for providing software sharing among terminals, the system including, for example, a first terminal 801, a second terminal 802, and a server 803.

The first terminal 801 can generate, in accordance with a terminal ID of the first terminal and a first installation package address, a second software installation package address including the terminal ID of the first terminal. The first software installation package address can be used by the first terminal for obtaining an address of a first installation package of shared software. The first shared software installation package can be used by the first terminal for installing the shared software. The first terminal 801 can also transmit software sharing information including an address of a second software installation package to the second terminal.

The second terminal can receive the software sharing information transmitted from the first terminal. The address of the second software installation package can include the terminal ID of the first terminal. The second terminal can transmit, in accordance with the address of the second software installation package, an acquisition request for a second shared software installation package to the server and install the shared software in accordance with the second shared software installation package. The second shared software installation package can include the terminal ID of the first terminal.

The server can receive the acquisition request for the second installation package transmitted from the second terminal. The acquisition request can include a shared software ID and a sharing party ID. The shared software ID can identify the shared software being requested for acquisition. The sharing party ID can identify a sharing party providing the address of the shared software installation package to the second terminal. The sharing party can include one of the first terminal, the second terminal, or the server. The server can obtain, in accordance with the shared software ID, a default software installation package corresponding to the shared software ID, and generate the second shared software installation package in accordance with the default software installation package and the sharing party ID. The second shared software installation package can include the sharing party ID. The server can transmit the second shared software installation package to the second terminal, allowing installation at the second terminal the shared software in accordance with the second shared software installation package.

This embodiment discloses obtaining the second shared software installation package transmitted by the server in accordance with the address of the second software installation package transmitted by the first terminal visiting the server, installing the shared software using the second installation package, and transmitting the terminal IDs of the first terminal and the second terminal to the server in accordance with the second software installation package. This can facilitate the server determining the sharing party sharing the software with the second terminal to be the first terminal in accordance with the terminal IDs of the first terminal and second terminal, using the method in the above-described embodiment. As a result, this can provide better utilization for the operator.

It should be noted that, although each of the steps described in the embodiments above is performed by the individual modules in these embodiments, different modules can perform each of these steps in operation. That is, the modules can be reconfigured to form different functional modules for performing some or all of the above-described steps.

The order in which the above embodiments are described does not represent any preference among the embodiments.

In accordance with the above-described embodiments, a person skilled in the art can understand that parts of or the whole process described in each of the above embodiments can be performed by hardware in accordance with instructions from one or more computer programs. The one or more computer programs can be stored in a non-transitory readable medium, which can be read-only memory (ROM), a floppy disk, or a CD.

In some embodiments, one or more of the modules and/or units in FIGS. 5-9 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The non-transitory computer readable storage medium can be part of a computing system serving as one of the terminals or servers. FIG. 12 illustrates exemplary common components of one such computing system. As illustrated, the system 1200 can include a central processing unit (CPU) 1202, I/O components 1204 including, but not limited to one or more of display, keypad, touch screen, speaker, and microphone, storage medium 1206 such as the ones listed in the last paragraph, and network interface 1208, all of which can be connected to each other through a system bus 1210. The storage medium 1206 can include the modules of FIGS. 5-9 if the system is a terminal or server in one of the embodiments discussed above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method of sharing software among terminals, the terminals comprising at least a first terminal and a second terminal, the method comprising:
receiving an acquisition request, transmitted from the second terminal, for a second shared software installation package, the acquisition request comprising a shared software ID and a sharing party ID, the shared software ID identifying the shared software, the sharing party ID identifying a sharing party providing an address of the shared software installation package to the second terminal, the sharing party being one of the first terminal, the second terminal, and a current server,
obtaining, in accordance with the shared software ID, a default software installation package corresponding to the shared software ID,
generating, in accordance with the default software installation package and the sharing party ID, the second shared software installation package, the second shared software installation package comprising the sharing party ID, and
transmitting, to the second terminal, the second shared software installation package, allowing installation at the second terminal of the shared software using the second shared software installation package.

2. The method of claim 1, comprising: after transmitting the second shared software installation package to the second terminal,
obtaining a terminal ID of the second terminal and the sharing party ID; and
determining the sharing party in accordance with the terminal ID of the second terminal, the sharing party ID, and a default server ID.

3. The method of claim 2, wherein determining the sharing party in accordance with the terminal ID of the second terminal, the sharing party ID, and a default server ID comprises:
when the sharing party ID is the same as the terminal ID of the second terminal, determining the sharing party to be the second terminal,
when the sharing party ID is the same as the default server ID, determining the sharing party to be the current server, and
when the sharing party ID is different from both the terminal ID of the second terminal and the default server ID, determining the sharing party to be the first terminal.

4. A method of sharing software among terminals, comprising:
receiving software sharing information transmitted from a first terminal, the software sharing information comprising an address of a second shared software installation package, the address of the second shared software installation package comprising a terminal ID of the first terminal,
transmitting, to a server, an acquisition request for the second shared software installation package in accordance with the address of the second shared software installation package, the acquisition request comprising a shared software ID and a sharing party ID, and
receiving the second shared software installation package from the server, and installing the shared software in accordance with the second shared software installation package, the second shared software installation package comprising the terminal ID of the first terminal,
wherein the first terminal comprises the sharing party providing the address of the second installation package to a second terminal, and the terminal ID of the first terminal comprises the sharing party ID.

5. The method of claim 4, comprising: after installing the shared software in accordance with the second shared software installation package,
transmitting the terminal IDs of the first terminal and the second terminal to the server, allowing the server to determine, in accordance with the terminal IDs of the first terminal and the second terminal, the sharing party sharing the shared software to be the first terminal.

6. A method of sharing software among terminals, comprising:
generating, in accordance with a terminal ID of a first terminal and an address of a first software installation package, an address of a second software installation package, the address of the second software installation package comprising the terminal ID of the first terminal, the address of the first software installation package comprising an address at which the first terminal obtains the first software shared software installation package, the first software installation package comprising an installation package used by the first terminal for installing the shared software, and
transmitting, to the second terminal, software sharing information comprising an address of a second software installation package, allowing the second terminal to obtain the second software installation package in accordance with the address of the second software installation package.

7. The method of claim 6, wherein generating, in accordance with the terminal ID of the first terminal and the address of a first software installation package, the address of the second software installation package comprises:
obtaining a default configuration path in the address of the first software installation package, and
setting the terminal ID of the first terminal as a follow-up path of the default configuration path to obtain the address of the second software installation package.

8. A server comprising:
a software installation package acquisition obtaining module that receives an acquisition request for a second installation software of a shared software from a second terminal, the acquisition request comprising a shared software ID and a sharing party ID, the shared software ID identifying the shared software requested to be acquired, the sharing party ID identifying a sharing party providing the address of the shared software installation package to the second terminal, the sharing party can be one of a first terminal, the second terminal, and a current server,
a default software installation package obtaining module that obtains, in accordance with the shared software ID, a default software installation package corresponding to the shared software ID,
a shared software installation package generating module that generates, in accordance with the default software installation package and the sharing party ID, the second shared software installation package, the second installation package of the shared package comprising the sharing party ID, and
a shared software installation package transmitting module that transmits the second shared software installation package to the second terminal, allowing installation at the second terminal the shared software in accordance with the second shared software installation package.

9. The server of claim 8, comprising:
an ID obtaining module that obtains a terminal ID of the second terminal and the sharing party ID, and
a sharing party determining module that determines the sharing party in accordance with the terminal ID of the second terminal, the sharing party ID, and a default server ID.

10. The server of claim 9, wherein the sharing party determining module is configured to:
when the sharing party ID is the same as the terminal ID of the second terminal, determining the sharing party to be the second terminal,
when the sharing party ID is the same as the default server ID, determining the sharing party to be the current server, and
when the sharing party ID is different from both the terminal ID of the second terminal and the default server ID, determining the sharing party to be the first terminal.

11. The method of claim 1, wherein the acquisition request is transmitted by the second terminal in accordance with an address of the second shared software installation package.

12. The method of claim 11, wherein the address of the second shared software installation package comprises a terminal ID of the first terminal.

13. The method of claim 1, wherein the second software installation package comprises a terminal ID of the first terminal.

14. The method of claim 13, wherein the terminal ID of the first terminal comprises the sharing party ID.

15. The server of claim 8, wherein the acquisition request is transmitted by the second terminal in accordance with an address of the second shared software installation package.

16. The server of claim 15, wherein the address of the second shared software installation package comprises a terminal ID of the first terminal.

17. The server of claim 8, wherein the second software installation package comprises a terminal ID of the first terminal.

18. The server of claim 17, wherein the terminal ID of the first terminal comprises the sharing party ID.
